(19) United States
(12) Patent Application Publication
(10) Pub. No.: US 2006/0285513 A1
(43) Pub. Date: Dec. 21, 2006

(54) Method and apparatus for transmitting a frame synchronisation sequence and band extension information for a uwb multi-band cofdm wireless network

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/570,246

(22) PCT Filed: Aug. 23, 2004
(86) PCT No.: PCT/IB04/51534

§ 371 Date: Feb. 28, 2006

Related U.S. Application Data
(60) Provisional application No. 60/498,860, filed on Aug. 29, 2003.
(60) Provisional application No. 60/544,454, filed on Feb. 13, 2004.

(51) Int. Cl. H04Q 7/00

(52) U.S. Cl. 370/328

(57) ABSTRACT

The present invention provides a mechanism for alleviating a latency problem of one of the proposals for a potential IEEE 802.15.3a standard. The invention places band extension information into the frame sync sequence, as per the evolving standard, but places channel estimation information together with that of the 3-band channel estimation information using the actual TF code (909). The PLCP header (308) is transmitted using the actual TF code (909) and interleaver.

The present invention relates to an alternative frame synchronization sequence for wireless personal area networks.

System performance and spectral efficiency of ultra wide band (UWB) radio devices is an objective of ongoing research to determine the practical limits of spatial capacity and other parameters. There is a growing need for high data rates to transmit, e.g., video over air, and todays short-range wireless systems based on narrow band carrier modulation are inadequate or incapable of such high data rates. UWB radio systems, using simple modulation and appropriate coding schemes, can transit at rates in excess of 100 Mbs over short distances achieving a high data rate (HDR). Alternatively, UWB radios can increase link range at the expense of data rate, which can be combined with accurate location tracking capabilities for low data rate and location tracking (LDR/LT) capabilities. These complementary usages can be implemented based on architectures that are highly similar and have unprecedented scalability.

Spectral flexibility of UWB devices provides robust performance in the presence of narrowband interferers and co-location with other wireless devices. It also provides for operation in different regulatory environments since only the U.S. has regulations for UWB in place today. The IEEE 802.15.3a task group has addressed “spectral flexibility” with respect to how extensible Proposed implementations are at meeting differing or changing international regulations. Can UWB architectures be readily extended without changing the MAC or giving up backward compatibility to include newly allocated spectrum?

The FCC has ruled that UWB handheld devices may communicate with a uniform power spectral density in the range 3.1-10.6 GHz. The IEEE 802.15.3a standard is evolving to address potential cases where other countries adopt modified emission requirements and where permitted bands are added in the future.

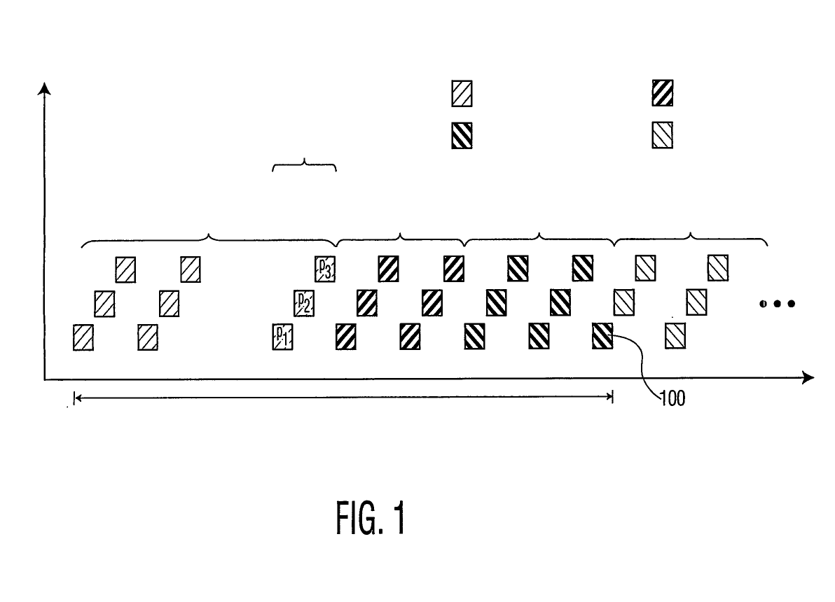

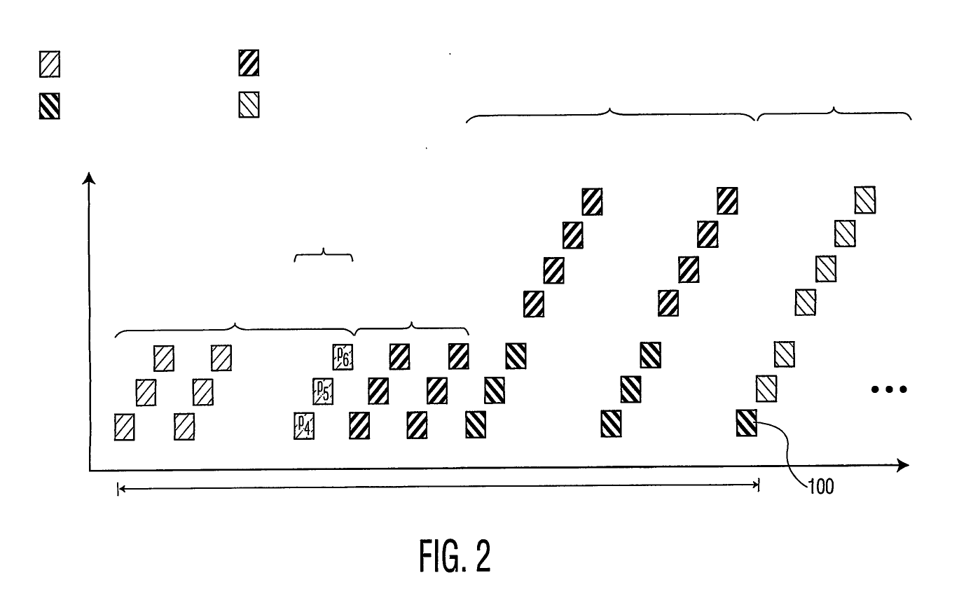

One of the proposals to the IEEE 802.15.3a standardization task group uses a multi-band OFDM system for UWB HDR wireless personal area networks (WPANs) having a maximum distance of 20.5 m in AWGN, and greater than 11 m in multipath environments for a mode 1 device. The proposal uses the frame sync sequence for band extension. For 3-band or mode 1, the preamble structure is illustrated in FIG. 1. For the 7-band or mode 2, the header and the channel estimation extension (band extension) are interleaved, see FIG. 2. The MAC handles an additional band by assigning this new band to an already existing field in the MAC that already is there supporting the bands allocated today. The PHY handles this change by adding the required transmitter and receiver circuitry to support the additional UWB band.

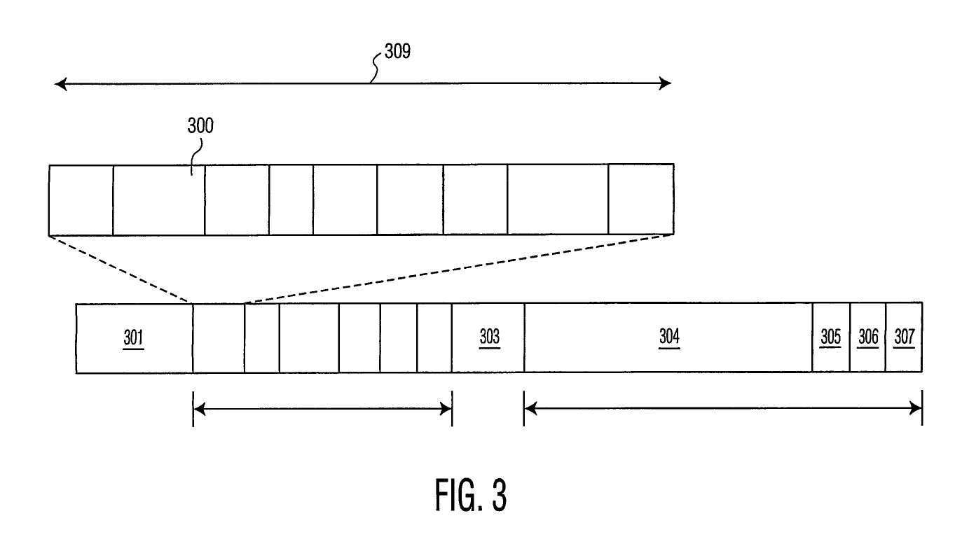

The band extension information is placed into the PHY header. The channel estimation information follows the PLCP header. The header is extended by 1 COFDM symbol 100. A 100-bit interleaver is used for the PLCP header, see FIG. 3.

The proposal has several advantages: the number of reserved bits has increased from 2 to 7; the number of tail bits for the PLCP header has increased; and, the number of RATE bits has increase from 3 to 4 so that 16 data rates can be supported.

However, the evolving IEEE 802.15.3a proposal also has several disadvantages: it constrains the design of the receiver by placing channel estimated after the PLCP header; and, depending on the design of the receiver, there is a potential latency problem. There is some loss of burst error performance due to the use of the 100-bit interleaver. The PLCP header is still transmitted over 3 bands even though 7 bands are available with the result that there is a potential SOP performance impact on the PLCP header. Finally, for small size packets there is an impact on throughput, but this impact is minor for long packets.

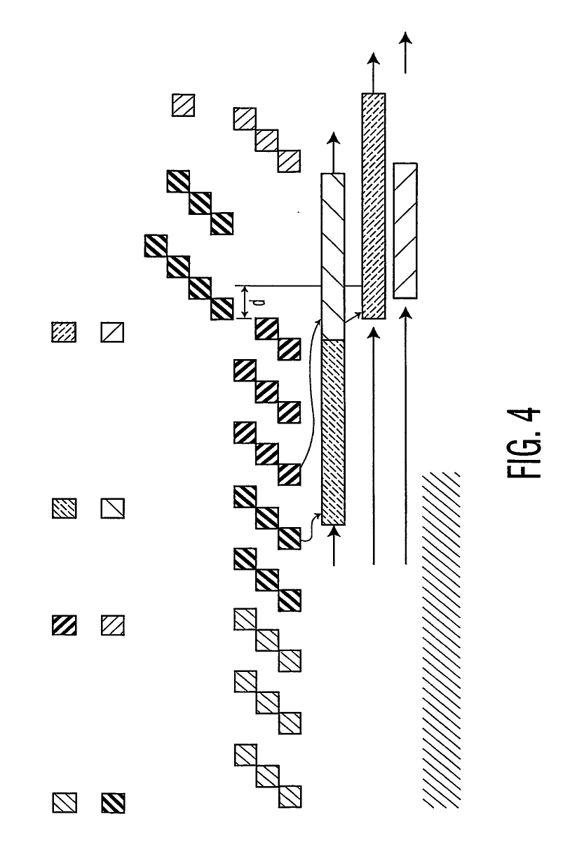

With respect to the potential for a latency problem, referring now to FIG. 4, if channel estimation takes about 9 OFDM symbol times, a latency of at least 1 OFDM symbol time will result and, thus, there will not be sufficient time to close the loop to the mixer. The receiver design must be highly constrained to meet the latency requirement. This compromises performance.

The present invention provides a mechanism for alleviating the above-described latency problem of the proposed IEEE 802.15.3a proposal. The invention places band extension information into the frame sync sequence, as per the proposed standard, but places channel estimation information together with that of the 3-band channel estimation information using the actual TF code. The PLCP header is transmitted using the actual TF code and interleaver.

In a preferred embodiment, for each symbol, one out of four possible signals is transmitted as a frame sync by using one of three possible options for the frame sync sequence which is spread using a sequence of length 8.

This approach eliminates the latency problem with no change of structure, provides a seamless processing of channel estimation and PLCP header decoding with no increase in the PLCP header information and is as reliable as detecting the frame sync.

FIG. 1 illustrates a PLCP preamble for Mode 1 (3-band) device;

FIG. 2 illustrates a PLCP preamble for Mode 2 (7-band) device;

FIG. 3 illustrates the IEEE 802.15.3a proposed packet format, highlighting the format of the PHY header;

FIG. 4 illustrates a latency analysis of the IEEE 802.15.3a draft proposal;

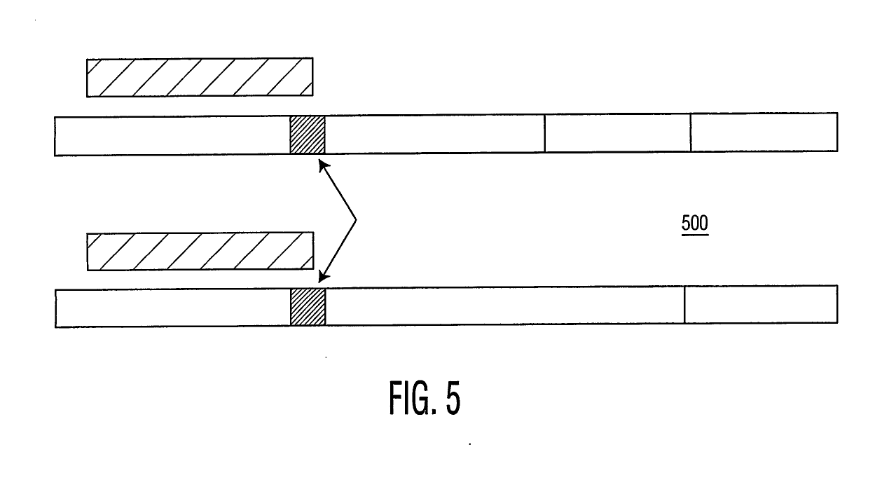

FIG. 5 illustrates the packet structure of the present invention;

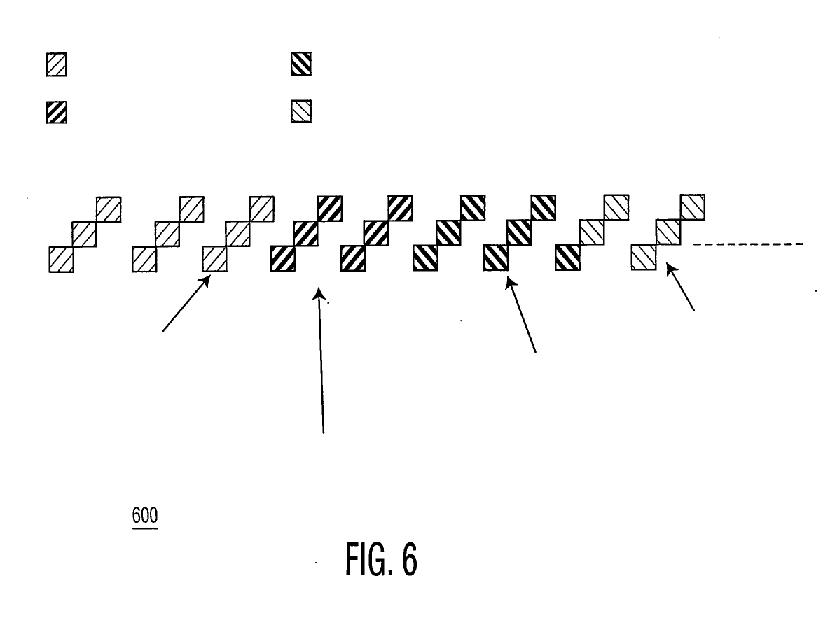

FIG. 6 illustrates a PLCP preamble for Mode 1, according to an embodiment of the present invention;

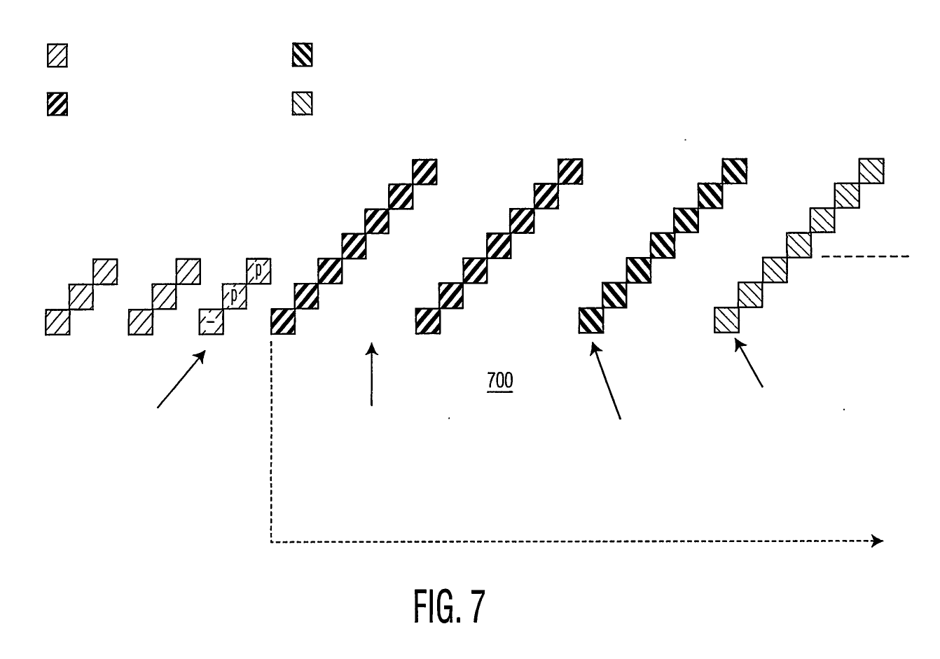

FIG. 7 illustrates a PLCP preamble for Mode 2 (7-band), according to an embodiment of the present invention;

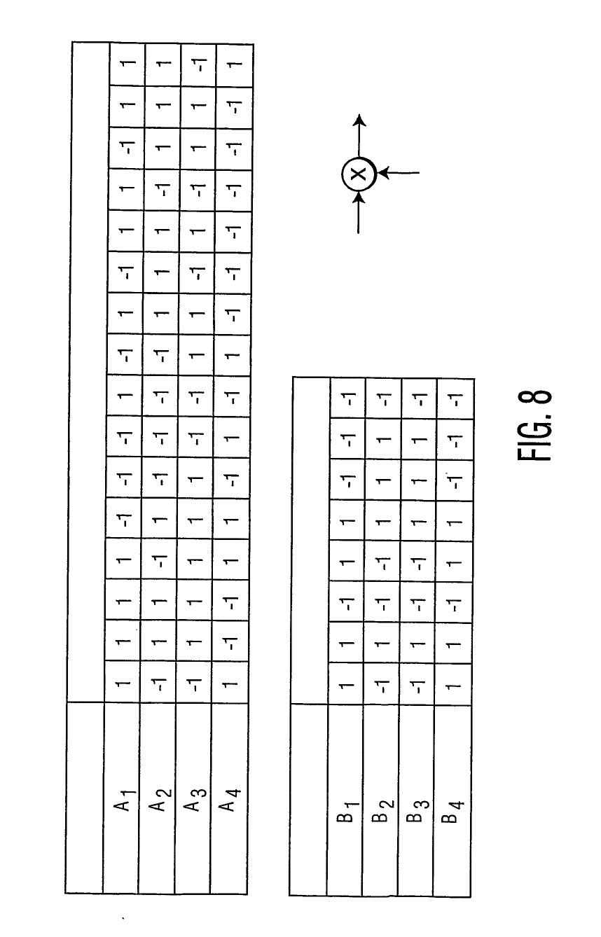

FIG. 8 illustrates the IEEE 802.15.3 draft preamble pattern;

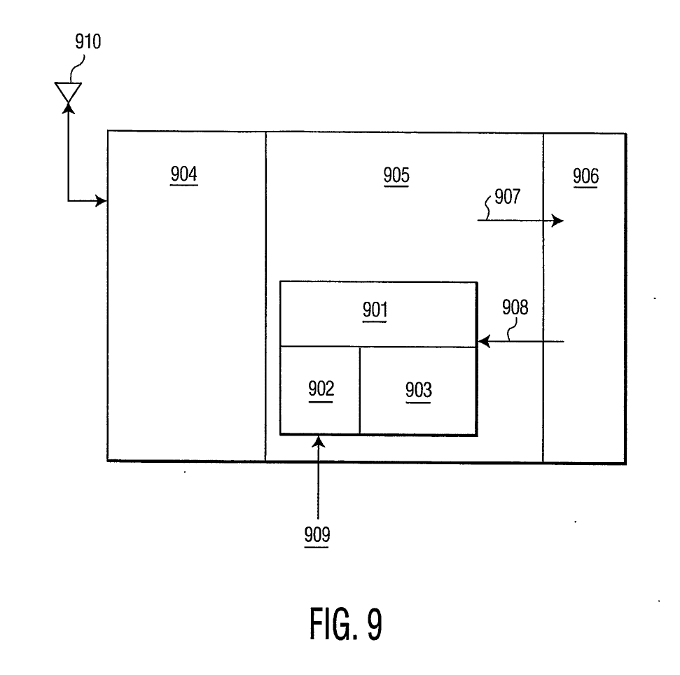

FIG. 9 illustrates an embodiment of a transceiver according to an embodiment of the present invention;

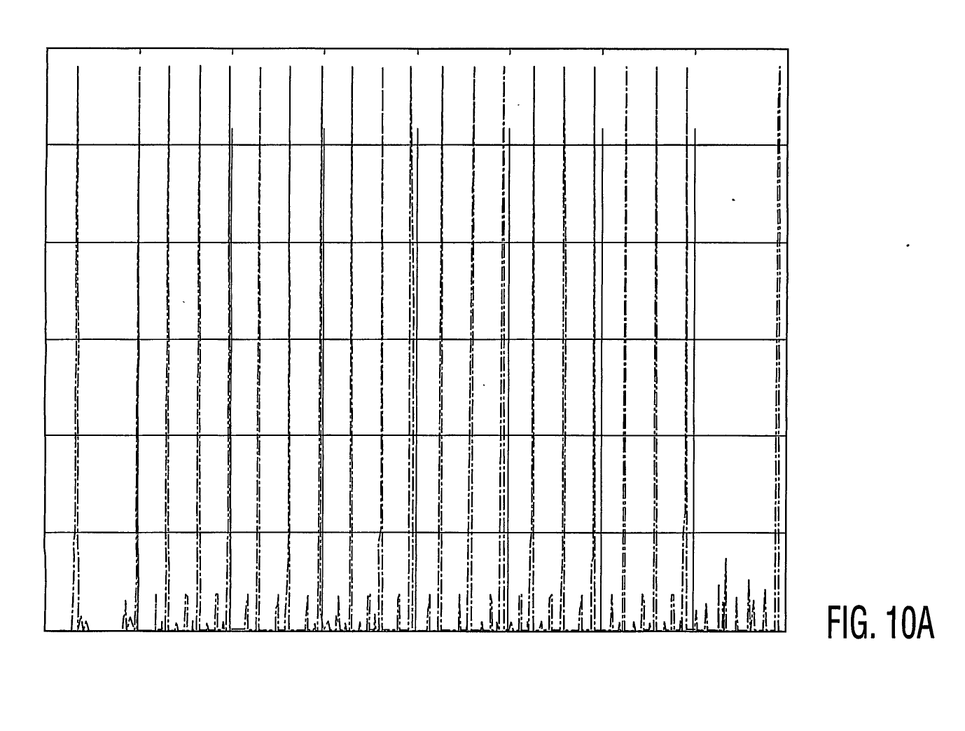

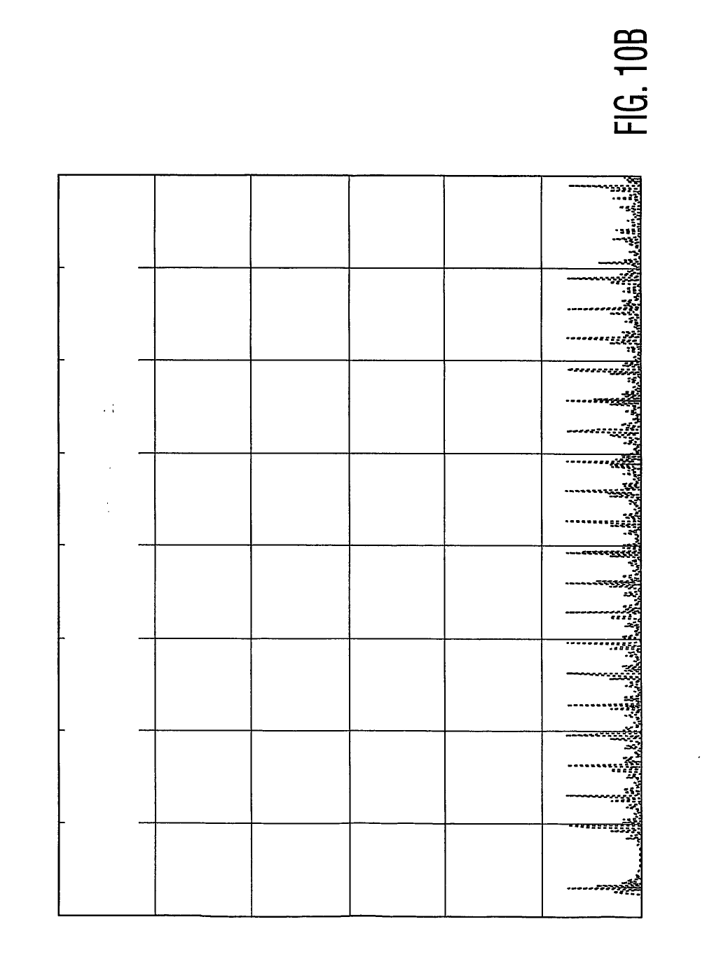

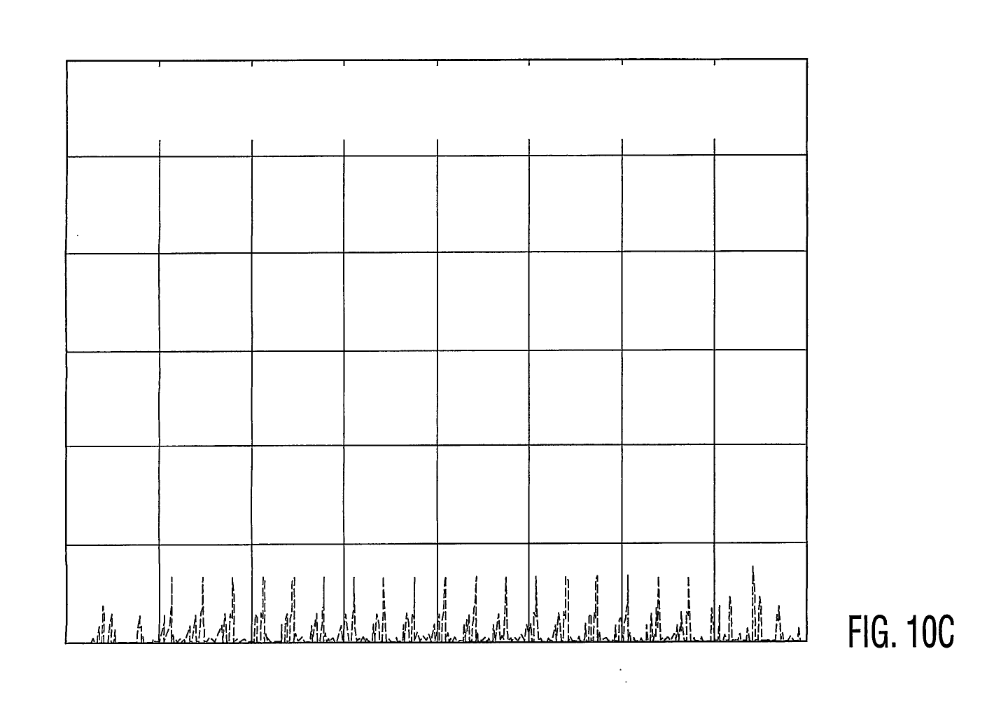

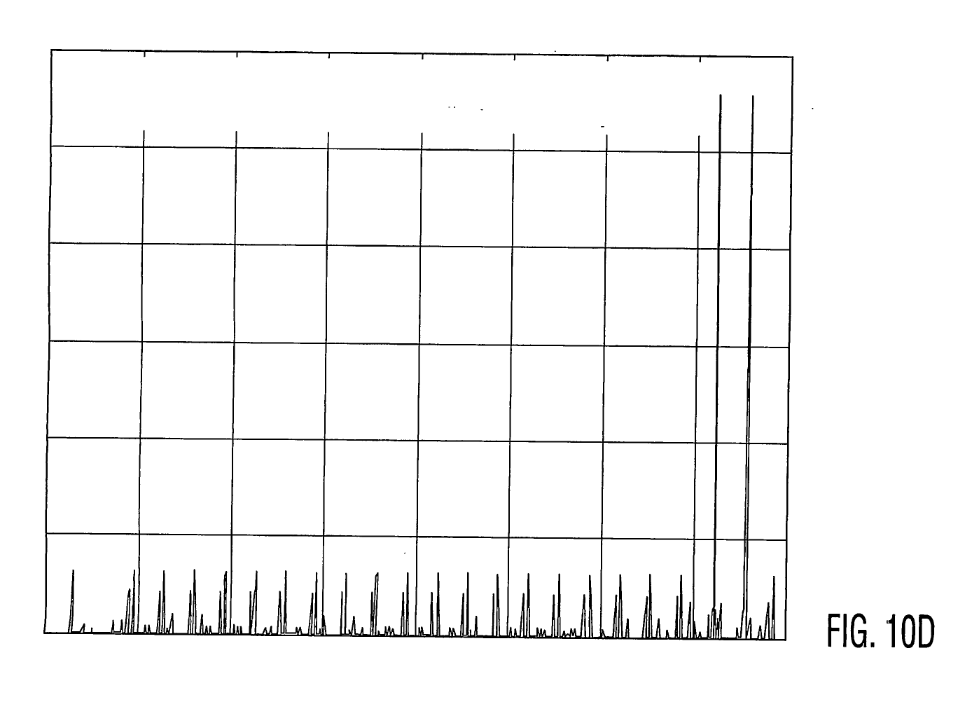

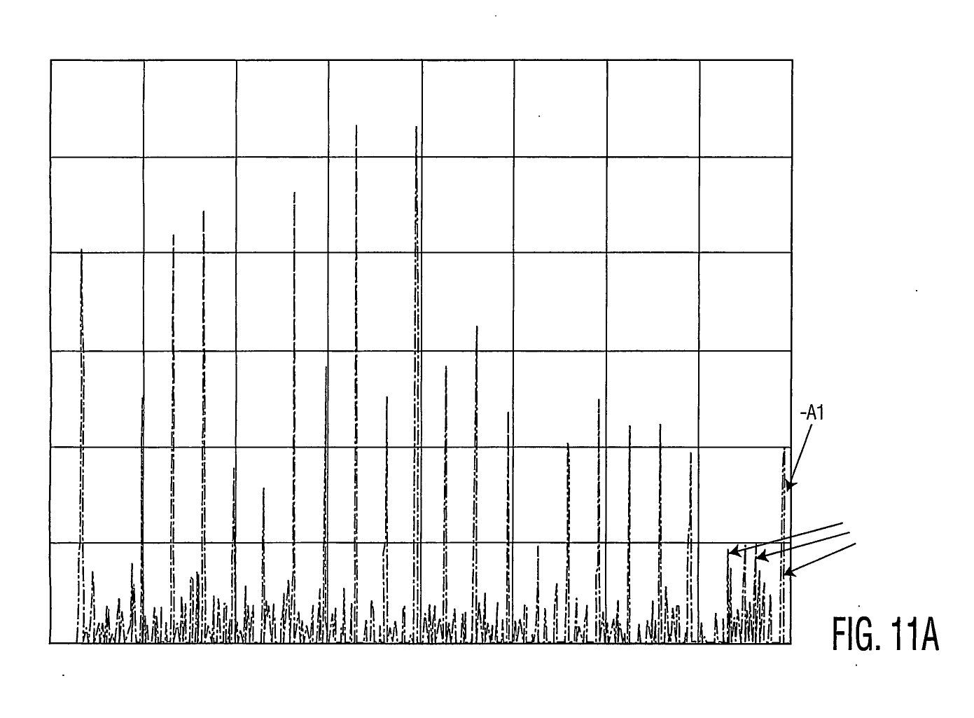

FIG. 10 illustrates correlation output for time-domain sequence from actual simulation in an ideal channel, 110 Mb/s for a transmitted frame sync sequence: flip (A), flip (A1);

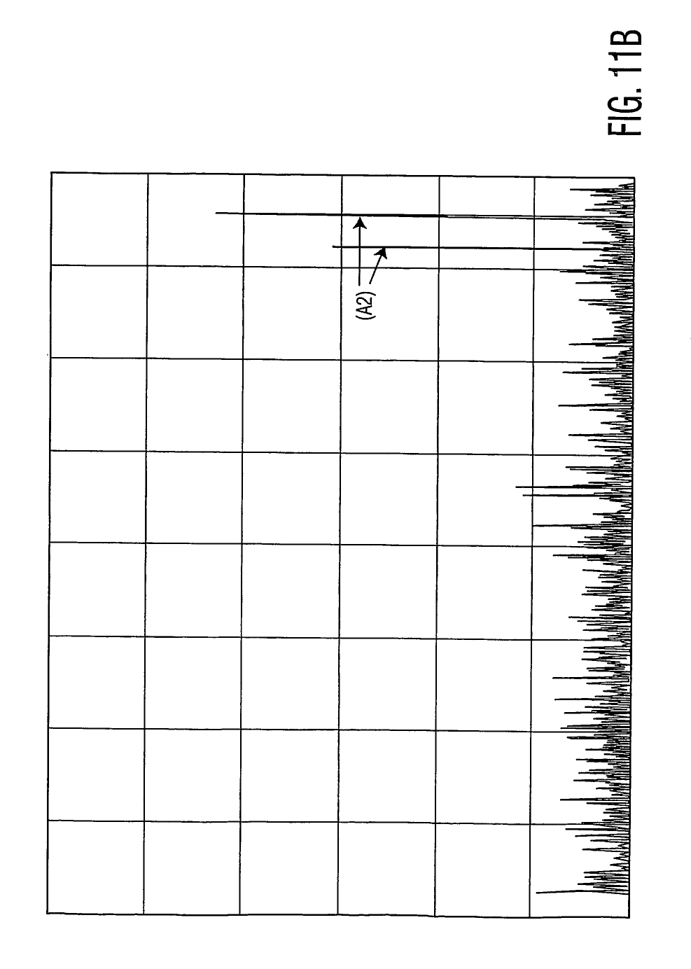

FIG. 11 illustrates simulation results for AWGN channel and 1 dB Eb/NO, 110 Mb/s mode; and

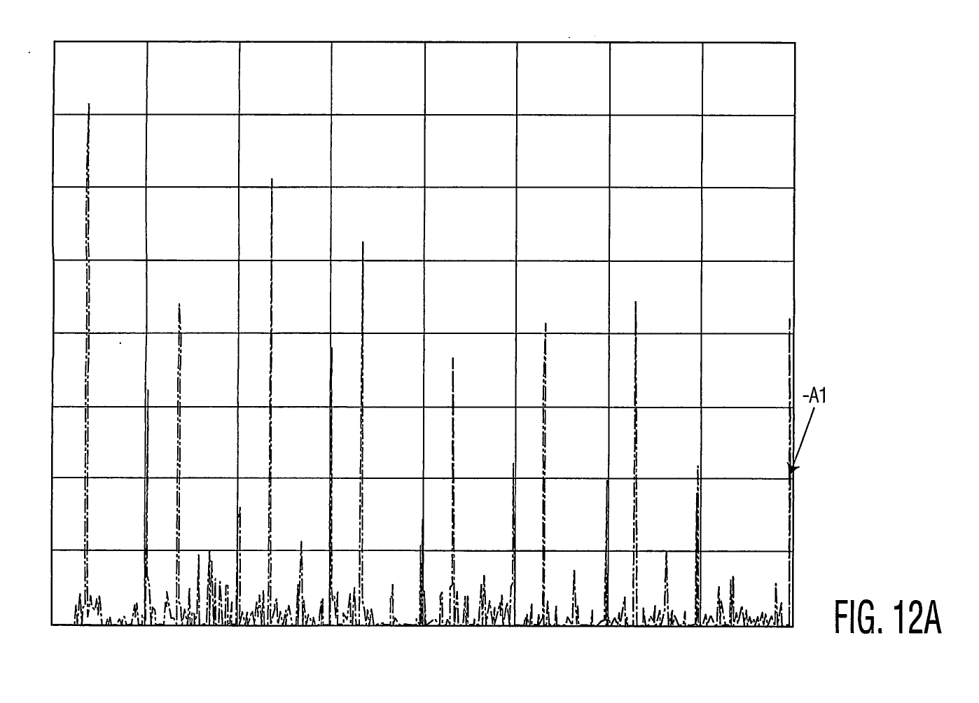

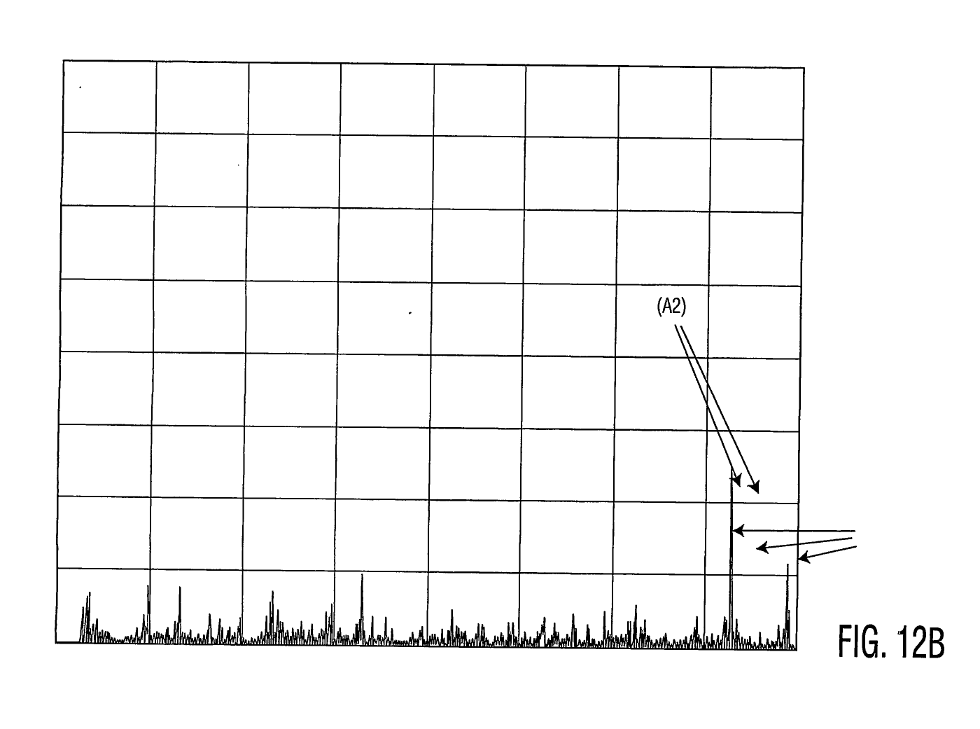

FIG. 12 illustrates simulation results for CM4-1 and 6 dB Eb/NO, 110 Mb/s mode.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In the evolving IEEE 802.15.3a proposal, the PLCP preamble is designed to allow both Mode 1 (3-band) and Mode 2 (7-band) devices to operate in the same piconet. Therefore, all devices in the same piconet must be able to detect the preamble and demodulate the PHY/MAC header of the PLCP header.

Referring now to FIG. 3, the system and method of the present invention places band extension information into the frame sync sequence, as per the evolving IEEE 802.15.3a standard, but places channel estimation information together with that of the 3-band channel estimation information using the actual time frequency (TF) code. The PLCP header is transmitted using the actual TF code and interleaver, as illustrated in FIGS. 5-7.

For each symbol, one our of four possible sequences A=(A1, A2, A3, A4) is selected as a frame sync and transformed using one of three possible options:
1. time-flipping, i.e., sending the last first and the first last;
2. phase inversion; and
3. using one of the time-flipped version of A=(A1, A2, A3, A4) with a pre-determined exclusion.
   The transformed selection is then spread using one of four possible sequences B=(B1, B2, B3, B4) of length 8, see FIG. 8a.

Six bits of information can be transmitted by the frame sync symbols. In a preferred embodiment, a simple rate ½ code is used to improve performance. In one embodiment this is spreading three bits across three bands. In an alternative embodiment, just three bits of information are transmitted.

A preferred embodiment uses the preamble-sensing hardware with minor additional hardware and for CCA parallel scanning of the preamble may be performed. Implementation is greatly eased because channel estimation is contiguous.

The actual TF code is used during both channel estimation and PLCP header decoding. This TF code is known a priori since it is related to the preamble sequence.

The present invention eliminates the latency problem of the evolving standard discussed above with no change of structure, provides seamless processing of channel estimation and PLCP header decoding with no increase in the PLCP header information, and is a reliable as detecting the frame sync.

FIG. 9 illustrates a block diagram of an example system architecture incorporating an embodiment of the present invention. As shown in FIG. 3, the PLCP preamble 301 is sent first, followed by the PLCP header 302, followed by an optional band extension sequence 303, followed by the frame payload 304, the FCS 305, the tail bits 306, and finally the pad bits 307. The PLCP header 302 is always transmitted using Mode 1. The remainder of the PLCP frame (frame payload 304, FCS 305, tail bits 306, and pad bits 307) is sent at the desired information data rate of 55, 80, 110, 160, 200, 320, or 480 Mb/s using either Mode 1 or Mode 2. If the frame payload 304 is transmitted using Mode 2, then an optional band extension field follows the PLCP header 302. The optional band extension field 303 is not used when the frame payload 304 is transmitted using Mode 1.

A typical OFDM transceiver comprises an Antenna 910 for sending an receiving signal received from and provided to an RF/Analog section 904 that is operably coupled to a Digital PHY section 905 which, in turn, delivers data 907 to a MAC section 906 and received data 908 therefrom.

Simulation results are illustrated in FIGS. 10-12. FIG. 10 illustrates correlation output for time-domain sequence from actual simulation in an ideal channel, 110 Mb/s for a transmitted frame sync sequence of flip (A1), flip (A1), (−A). This sequence exhibited very good cross-correlation property (−21 dB isolation). FIG. 11 illustrates simulation results for AWGN channel and 1 dB Eb/NO, 110 Mb/s mode for a transmitted frame sync sequence of flip (A2), flip (A2), (−A1). Synchronization was possible, frame sync data was decodable, but payload data was not decodable at this SNR and channel. FIG. 12 illustrates simulation results for CM4-1 and 6 dB Eb/NO, 110 Mb/s mode for a transmitted frame sync sequence of flip(A2), flip(A2), (−A1). Synchronization was possible, frame sync data was decodable, but payload data was not decodable at this SNR and channel.

The transceiver and method of the present invention can be used for wireless personal area networks, for conveying video, audio, text, picture, and data, for controlling sensors, alarms, computers, audio-visual equipment, and entertainment systems. For example, the contents of a digital camera can be downloaded to a computer wirelessly.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the appended claims. This is especially pertinent due to the expected evolution of the UWB spectrum and is anticipated by the appended claims and is expressed in the forgoing disclosure.

What is claimed is:

1. A method of providing band expansion for a multi-band wireless personal area network, comprising the steps of:
(a) including band extension information (300) in a PLCP header (308) of an encoded digital data stream;
(b) after the PLCP header (308) of the encoded digital data stream, placing channel estimation information together with the 3-band channel estimation information using the actual time frequency code (909) (600) (700);
(c) transmitting the encoded digital data stream across multi-bands that include the band extension;
(d) using the actual time frequency code (909), decoding a PLCP header of a received encoded digital data stream that contains band extension information (905); and
(e) demodulating (905) the multi-band stream using the band extension information of the decoded PLCP header.

2. The method of claim 1, wherein the multi-band wireless personal area network is an ultra wide band coded orthogonal frequency division (UWB COFDM) network.

3. The method of claim 1, wherein said including step (a) further comprises the step of
(a.1) placing the band extension information into the frame sync sequence of the PLCP header (500).

4. The method of claim 3, wherein said including step (a) further comprises the steps of:
(a.2) for each symbol, selecting as a frame sync, one sequence of a first predetermined set of four sequences A=(A1, A2, A3, A4);
(a.3) transforming the selected sequence using a mapping selected from the group consisting of time-flipping, phase inverting, and using one of the time-flipped version of (A1, A2, A3, A4) with a predetermined exclusion; and
(a.4) spreading the transformed frame sync sequence using one sequence of a second predetermined set of four sequences B=(B1, B2, B3, B4).

5. The method of claim 4, wherein:
the frame sync comprises at most six bits of information; and
a simple rate ½ code is used.

6. The method of claim 5, wherein said simple rate ½ code comprises the step of (a.4.1) spreading three bits across three bands.

7. The method of claim 5, wherein the frame sync comprises three bits of information.

8. A method for extending the bands used by a multi-band transmitter, comprising the steps of:
a) including band extension information (300) in the frame sync sequence of a PLCP header (308) of an encoded digital data stream;
(b) after the PLCP header (308) of the encoded digital data stream, placing channel estimation information together with the 3-band channel estimation information using the actual time frequency code (909) (600) (700); and
(c) transmitting the encoded digital data stream across multi-bands that include the band extension.

9. The method of claim 8, wherein said including step (a) further comprises the steps of:
(a.2) for each symbol, selecting as a frame sync, one sequence of a first predetermined set of four sequences A=(A1, A2, A3, A4);
(a.3) transforming the selected sequence using a mapping selected from the group consisting of time-flipping, phase inverting, and using one of the time-flipped version of (A1, A2, A3, A4) with a predetermined exclusion; and
(a.4) spreading the transformed frame sync sequence using one sequence of a second predetermined set of four sequences B=(B1, B2, B3, B4).

10. The method of claim 9, wherein:
the frame sync comprises at most six bits of information; and
a simple rate ½ code is used.

11. The method of claim 10, wherein said simple rate ½ code comprises the step of (a.4.1) spreading three bits across three bands.

12. The method of claim 10, wherein the frame sync comprises three bits of information.

13. A method for extending the bands used by a multi-band receiver, comprising the steps of:
(a) using the actual time frequency code (909), decoding (905) a PLCP header of a received encoded digital data stream to obtain band extension information contained in the frame sync sequence; and
(b) demodulating (905) the multi-band stream using the band extension information obtained from the decoded PLCP header.

14. The method of claim 13, further comprising the step of (c) for clear channel assessment (CCA), performing parallel scanning of the PLCP preamble (308).

15. A high-speed digital data stream of a plurality of symbols that are embodied in a carrierless ultra wideband signal, comprising:
a PLCP preamble (301) including in a frame sync sequence thereof a first band extension information;
a PLCP header (308) including in a PHY header (309) thereof a second band extension information (300) and at the end of said PLCP header including an optional third band extension information (303);
wherein, said PLCP header (302) is transmitted using an actual time frequency (TF) code (909) and an interleaver.

16. The signal of claim 15, wherein:
for each symbol of said plurality, one our of four possible sequences A=(A1, A2, A3, A4) of length 16 is selected as a frame sync and transformed using one of three possible options:
1. time-flipping, i.e., sending the last first and the first last;
2. phase inversion; and
3. using one of the time-flipped version of A=(A1, A2, A3, A4) with a pre-determined exclusion; and
the transformed selection is then spread using one of four possible sequences B=(B1, B2, B3, B4) of length 8.

17. The signal of claim 16, wherein:
the frame sync comprises at most six bits of information; and
a simple rate ½ code is used.

18. The signal of claim 17, wherein said simple rate ½ code comprises spreading three bits across three bands.

19. The signal of claim 17, wherein the frame sync comprises three bits of information.

20. A transceiver for a carrierless ultra wideband signal embodying a high-speed digital data stream of a plurality of symbols, comprising:
an antenna (910) for sending and receiving a UWB signal;
an RF/Analog section (904) comprising an interleaver and operably coupled to the antenna for detecting a PLCP preamble (301) of the received signal, modulating and demodulating a PLCP header of the signal using an actual time frequency (TF) code (909) and said interleaver;
a Digital PHY section (905) operably coupled to the RF/Analog section (904) and comprising a PLCP encoder/decoder (901) that uses the actual TF code (909) for (1) channel estimation (903), placing said channel estimation information together with that of a 3-band channel estimation information, and (2) PLCP header decoding, and that places band extension information into a frame sync sequence (902) of the PLCP preamble (301) and, optionally, after the PLCP header (308), selecting, transforming and spreading said frame sync;
a MAC section (906) operably coupled to the Digital PHY section (905) for providing and input data stream (908) and receiving a demodulated and decoded data stream (907) therefrom.

21. The transceiver of claim 20, wherein:
for each symbol of said plurality, one our of four possible sequences A=(A1, A2, A3, A4) of length 16 is selected as a frame sync and transformed using one of three possible options:
1. time-flipping, i.e., sending the last first and the first last;
2. phase inversion; and
3. using one of the time-flipped version of A=(A1, A2, A3, A4) with a pre-determined exclusion; and
the transformed selection is then spread using one of four possible sequences B=(B1, B2, B3, B4) of length 8.

22. The signal of claim 21, wherein:
the frame sync comprises at most six bits of information; and
a simple rate ½ code is used.

23. The signal of claim 22, wherein said simple rate ½ code comprises spreading three bits across three bands.

24. The signal of claim 23, wherein the frame sync comprises three bits of information.
